(19) United States
(12) Patent Application Publication
(10) Pub. No.: US 2010/0328443 A1
(43) Pub. Date: Dec. 30, 2010

(54) SYSTEM FOR MONITORING PATIENT SAFETY SUITED FOR DETERMINING COMPLIANCE WITH HAND HYGIENE GUIDELINES

(76) Inventors: Donald S. Lynam, Madison, WI (US); Robert B. Tweed, Madison, WI (US)

Correspondence Address: Intellectual Property Department;DEWITT ROSS & STEVENS S.C., Suite 600, 2 East Mifflin Street, Madison, WI, 53703-2865, US

(21) Appl. No.: 12/823,909

(22) Filed: Jun. 25, 2010

Related U.S. Application Data
(60) Provisional application No. 61/220,824, filed on Jun. 26, 2009.

(51) Int. Cl. H04N 7/18

(52) U.S. Cl. 348/77; 348/E07.085

(57) ABSTRACT

An exemplary method and system monitors patient safety to, for example, minimize disease transmission from healthcare providers with unclean hands to patients and their surroundings. Signals (for example, infrared and radio frequency) among an area monitor, identification badge, and cleaning agent dispenser help locate and identify objects (persons and equipment). Objects may be identified and monitored using object recognition and motion tracking, zones (around the objects) are defined based on proximity to the object, and subzones are defined within zones to enhance monitoring of compliance with hygiene guidelines. The movements of objects may be monitored using motion tracking, and the objects may be identified by detecting a signal pulse in the object's silhouette. A caretaker entering a zone, moving between subzones, or contacting objects without dispensing cleaning agent from a dispenser can be alerted that they have unclean hands. Observations can be automatically recorded for real-time alerting and auditing purposes.

### CROSS-REFERENCE TO RELATED APPLICATIONS

This application claims priority under 35 USC §119(e) to U.S. Provisional Patent Application 61/220,824 filed Jun. 26, 2009, the entirety of which is incorporated by reference herein.

### FIELD OF THE INVENTION

This document concerns an invention relating generally to a system for monitoring patient safety, and specifically to determining compliance with hand hygiene guidelines.

### BACKGROUND OF THE INVENTION

A recent Centers for Disease Control and Prevention (“CDC”) (Atlanta, Ga., U.S.A.) update estimates that “[i]n American hospitals alone, healthcare-associated infections [“HAIs”] account for an estimated 1.7 million infections and 99,000 associated deaths each year.” See http://www.cdc.gov/ncidod/dhqp/hai.html (last accessed Jun. 15, 2010). It has been estimated that the overall annual direct medical costs of HAIs to U.S. hospitals may be as high as 45 billion dollars. See R. Douglas Scott II, “The Direct Medical Costs of Healthcare-Associated Infections in U.S. Hospitals and the Benefits of Prevention” (March 2009), available at http://www.cdc.gov/ncidod/dhqp/pdf/Scott CostPaper.pdf. According to the CDC, keeping hands clean is one of the most important ways to prevent the spread of infection and illness.

The World Health Organization (“WHO”) (Geneva, Switzerland) recommends an approach that defines the key moments when HCWs should perform hand hygiene, referred to as the 5 Moments for Hand Hygiene. See http://www.who.int/gpsc/5 may/background/5moments/en/ (last accessed Jun. 15, 2010). This approach recommends that health-care workers clean their hands: (1) before touching a patient; (2) before clean/aseptic procedures; (3) after body fluid exposure/risk; (4) after touching a patient; and (5) after touching patient surroundings. See “WHO Guidelines on Hand Hygiene in Health Care” (May 2009), available at http://whqlibdoc.who.int/publications/2009/9789241597906 eng.pdf, the entirety of which is incorporated by reference herein.

Currently, the most effective means of determining compliance with hand hygiene guidelines is direct observation of interactions between patients and HCWs. This approach suffers from significant drawbacks, however, including high costs, observer bias, Hawthorne Effect (in which subjects being observed modify their behavior because they are being observed), and lack of sustainability and standardization. Real-time location systems are able to locate persons wearing a badge, but they are not able to monitor the interactions of persons with patients and their surroundings. Additionally, real-time location systems which use Wi-Fi or infrared signals (time of flight or time of arrival) are severely limited in accuracy, providing estimated locations which are one to three meters from actual locations, a range that is too great to be used to monitor whether patient contact occurs. Moreover, current cleaning agent dispensers are able to monitor access to cleaning agent, but they are not able to effectively associate the use of cleaning agent with interaction with patients. Further, current surveillance systems are not able to effectively distinguish between persons and objects in the system's field of view, the various zones around the persons and objects, and the interactions of HCWs, patients, and equipment through the zones.

Prodanovich and Heim disclose, in U.S. patent publication 2008/0100441, publication date May 1, 2008, a system for monitoring hand sanitizer use by means of Radio Frequency Identification (RFID) technology incorporated within a tag worn by the user. This tag communicates with the hand sanitizer dispenser to enable hand sanitizer application summaries for each user. Information on multiple user sanitization applications is stored in a system for future retrieval and processing by an administrator. While this system has a means to record and monitor sanitizer use for each user, no consideration is given to patient interaction as the defining factor for proper hand hygiene compliance monitoring.

Glenn and Swartz disclose, in U.S. patent publication 2008/0103636, publication date May 1, 2008, a system for providing automated hand washing and verifying compliance of use. In this invention, the user places his hands in automated cleaning devices that may be networked together. Through RFID, user identity and application data is retrieved for all users and devices. These data are retrieved by an administrator via server-generated reports for subsequent analysis. As noted with the Prodanovich invention, the Glenn invention makes no provision to monitor HCW/patient interaction, thereby limiting effectiveness. While hand sanitization events are recorded for each user, these users could choose to bypass the sanitizer stations and proceed with patient interaction, putting the patient at risk of contracting HAIs.

Sahud discloses, in U.S. patent publication 2008/0087719, publication date Apr. 17, 2008, a system for hand hygiene compliance monitoring through the use of data readers worn by users that are activated by portal triggers located in the doorway of patient rooms. RFID technology captures the user identity, and sanitizer application is recorded for each user as noted in the prior disclosures. The number of dispensing events and room entrance events are displayed on the reader, and this information is also summarized within a common database for subsequent analysis. The disclosed system, however, suffers from high maintenance requirements (such as frequent battery replacement) and inconvenient devices. True patient interaction detection is not a feature of the Sahud invention, limiting its ability to detect actual hand hygiene protocol compliance events.

Rice and Taneff disclose, in U.S. patent publication number 2005/0134465, publication date Jun. 23, 2005, a hand cleansing device that incorporates user identity detection and application monitoring in a manner similar to the Glenn publication. This invention incorporates the same limitations previously described with the Glenn disclosure.

Shaw and Adler disclose, in U.S. Pat. No. 5,812,059, issue date Sep. 22, 1998, a system to enhance hand cleanliness in food handling and hospital environments that incorporates an indicator that is worn by the worker. The indicator is activated when the worker enters a predetermined area proximate to the activating device. Activation is either audible or visual, and alerts on the indicator are deactivated upon hand sanitizing. This invention offers no provision for identity of the worker, nor does it capture worker hygiene adherence performance for summary reports. Functionality of this invention is similar to the Shaud invention. Both systems require significant worker interaction with the device as well as device maintenance. Yet another similar invention involving monitoring units with alert indicators worn by users is disclosed by Cohen, et al. in U.S. Pat. No. 6,236,317, issue date May 23, 2001. This patent is specifically targeted for applications with food preparation industries, and no provision is made for hospital patient interaction detection by the worker.

Segal discloses, in U.S. Pat. No. 5,793,653, issue date Aug. 11, 1998, a means by which hand sink use regimen can be monitored, along with the identities of the users. This invention also incorporates the linking of multiple sinks together to provide summary user information. User identity is captured via manual keypad entry, barcode, magnetic strip reader, etc. No patient interaction detection is offered and manual data input can easily be overlooked by the user.

What is needed is an effective system for automatically monitoring patient safety and compliance with hygiene compliance guidelines.

### SUMMARY OF THE INVENTION

The invention, which is defined by the claims set forth at the end of this document, is directed to a system for monitoring patient safety which at least partially alleviates the aforementioned problems. A basic understanding of some of the features of preferred versions of the invention can be attained from a review of the following brief summary of the invention, with more details being provided elsewhere in this document. To assist in the reader's understanding, the following review makes reference to the accompanying drawings (which are briefly reviewed in the “Brief Description of the Drawings” section following this Summary section of this document).

Referring initially to FIG. 1 (which is not to scale), an exemplary method and system 10 (used interchangeably for convenience) monitors an area 100 (such as a hospital room and its immediate surroundings) to enhance patient safety. For example, an area/room monitor 20 minimizes the transmission of disease resulting from a service provider (such as a healthcare worker (“HCW”) 150 or any other provider of services) with unclean hands making contact with a person (such as a patient 160) or objects around the patient 160. Signals (for example, near-infrared (“IR”) and radio frequency (“RF”)) among the room monitor 20, a portable badge 40, 50, and a cleaning agent dispenser 60 help locate and identify objects (persons and equipment), and determine whether the HCW 150 has cleaned his or her hands. Objects (such as a patient bed 110 or a recliner in the hospital room) are identified using object recognition, zones 120, 130 (around the objects) are defined based on proximity to the object, and subzones are defined within the zones, such as subzones 122, 124, 126, 128 in zone 120. The movement of devices (such as mobile diagnostics equipment) and persons (such as the HCW 150 and the patient 160) in the area 100 may be monitored using motion tracking in images captured using a vision system so that it can be determined, for example, when the HCW 150 or patient 160 enters or exits one of the zones. Zones and subzones are also defined around patients 160 or other persons to detect contact and monitor interaction with the patients' 160 surroundings. If the HCW 150 enters one of the zones prior to dispensing the cleaning agent (such as a hand sanitizer, alcohol-based cleaning gel, or disinfecting soap) from the dispenser 60, one or more alerts can be communicated to the HCW 150 or to other staff. Observations of system 10 can be recorded for real-time alerting, auditing, analysis, reporting, or other purposes.

The vision system of the room monitor 20 preferably captures image frames (in the visible and infrared spectra) and performs video analytics (see discussion below). The vision system covers a field of view (“FOV”) 140 within the area 100. The FOV 140, which may be adjustable, need not encompass the entirety of area 100 at all times. The vision system may include a wide spectrum low-light image sensor and a wide-angle lens, and may include an IR filter that may be insertable/retractable from the video image path. An infrared system in the room monitor 20 may provide for both infrared communications (for example, by emitting IR signals with identifying information and detecting IR signals emitted by other components of system 10) as well as illumination (for example, by emitting IR light having an 830 nanometer (“nm”) wavelength that is different from the 940 nm IR used in communication) to help enable monitoring by the system 10 regardless of time or ambient lighting in the area 100. The FOV 140 preferably includes an entry 170 into the area 100, and most preferably includes all entrances 170 into the area 100 and all exits 170 from the area 100.

The room monitor 20 may emit a monitor line-of-sight signal (such as IR light having a wavelength of 940 nm) into the area 100. To enhance coverage of the area 100 with the monitor line-of-sight signal, the room monitor 20 may saturate a portion or substantially all of the area 100 being monitored by flooding a portion (or all) of the area 100 with the IR signal. The monitor IR signal may include (in its payload) information that uniquely identifies the area 100, such as a hospital room number or the wing of a hospital, to serve as validation of the source of the IR signal.

Referring to FIG. 7, when the HCW 150 carrying the badge 50 enters the area 100 being monitored, the badge may detect the IR signal being emitted by the room monitor 20 (represented by the black arrows pointing away from the room monitor 20 toward the HCW 150). The badge 50 may then emit a first non-line-of-sight signal (such as a low-power RF signal at 900 MHz) in response (represented by the curved lines (“waves”) originating from the badge 50 and growing in size (propagating) in the direction of the room monitor 20), and the first RF signal may be detected by the room monitor 20. The first RF signal preferably includes (in its payload) information uniquely identifying the HCW 150 who is carrying the badge 50. The payload of the first RF signal preferably also includes the area-identifying information received from the payload of the monitor IR signal. The room monitor 20 can in this way know which HCWs 150 have entered the area 100. Because the first RF signal includes area-identifying information in its payload, a second room monitor receiving the first RF signal from the badge 50 in a second area may know that the HCW 150 has not entered the second area.

In order to identify the HCW 150, the room monitor 20 may temporally associate receiving the first RF signal (which identifies the HCW 150 as well as the area 100 entered) emitted by the badge 50 with entry of the HCW 150 into the area 100. Alternatively or additionally, the room monitor 20 may determine and/or verify the identities of HCWs 150 (and/or patients 160 and other persons with badges) in the room by instructing badges 40, 50 in the area 100 to emit a badge line-of-sight pulse (such as IR light having a wavelength of 830 nm) using, for example, an IR light emitting diode (“LED”). The room monitor 20 may send to the badges 40, 50 an activate command, which includes information uniquely identifying the badge 40, 50 that is to emit the IR pulse. The badge 40, 50 may receive the activate command, and if the badge-identifying information in the activate command matches the identity of the badge 40, 50, the badge 40, 50 emits the IR pulse. The room monitor 20 may detect the badge IR pulse using its vision system, and the room monitor 20 may associate the position of the badge IR pulse with the pattern of the object (for example; the IR light may be detected within the silhouette/outline of the HCW 150) in the FOV 140 generated by the motion tracking system. If more than one HCW 150 is located in the area 100, the room monitor 20 may sequentially send an activate command to each badge 40, 50 in the area 100 in round-robin fashion. Each activate command in such sequential activation uniquely identifies the badge 40, 50 that is in turn to emit an IR pulse.

The room monitor 20 may identify an object (such as the bed 110) in the area 100 using object recognition (using, for example, the “on demand” module 380 of FIG. 3) by, for example, contrasting the texture of the object as compared with the floor. Some objects of interest, such as computer keyboards, may be detected using statistical pattern matching methods. Objects may be recognized, for example, by comparison with pictures of similar objects stored in the system 10, by comparison of the characteristics (such as length, width, height, color, etc.) of the object with reference dimensions, and/or by analysis of the object's relative position in the area 100 and its surroundings. The system 10 then preferably defines a contact zone 120 around the edges of the object based on proximity to the object. For example, the system 10 may define the contact zone 120 to include the object and a reachable distance around the object.

The reachable distance preferably extends from the edges of the recognized object (such as the bed 110) rather than from the geometric center of the object. This provides zones 120, 130 with outlines that substantially match the outline of the recognized object. For example, the zones 120, 130 in FIG. 1 have a rectangular shape corresponding with the rectangular shape of bed 110. This provides zones 120, 130 with edges which are equidistant from the edges of the bed 110 along the perimeters of the zones 120, 130 and bed 110. As shown in FIG. 9, if the bed 110 or other object is up against a wall (such that the HCW 150 would not be able to approach the patient 160 on the bed 110 from one or more directions), the zones 120, 130 may be adjusted such that one or more edges of the zones 120, 130 at least partly match the bed 110 edges which are against the wall. In FIG. 9, in which room monitor 20 is affixed to the wall above the head of bed 110, the head of bed 110 is next the wall and shares a boundary with zones 120, 130.

The reachable distance may be any distance within which the HCW 150 could or does make direct or indirect physical contact with the patient 160 in the bed 110, preferably ranging from zero inches to 24 inches. A hospital administrator, an infection control professional (“ICP”), or another authorized user can preferably modify the reachable distance (from a default of, for example, six inches or one foot). Setting the reachable distance to a distance of zero conceptually defines the contact zone 120 such that entering the contact zone 120 corresponds with making contact (or near-contact) with the patient 160. The accurate determination of actual contact (rather than, for example, near- or virtual-contact) in a given situation depends on such factors as conditions in the area 100 (for example, whether something is blocking the FOV) and the system's 10 margin of error. One or more subzones may be carved out within the contact zone 120 such as by, for example, defining first, second, third, and fourth (quadrant) contact subzones 122, 124, 126, 128. The contact subzones 122, 124, 126, 128 may represent, for example, the regions of the bed 110 over which the HCW 150 is likely to stand when examining different parts of the patient's 160 body or surroundings. In addition to the contact zone 120, the room monitor 20 may additionally define a caution zone 130 based on proximity to the object. The caution zone 130 preferably extends beyond the contact zone 120 to include a region that may suggest that the HCW 150 is approaching the patient 160, such as three feet around the bed 110, preferably ranging from two feet to eight feet. The contact and caution zones 120, 130 and subzones (such as 122, 124, 126, 128) therein preferably fall within the FOV 140 of the room monitor 20.

The HCW 150 may be identified (if not already identified) once the HCW 150 crosses into a dispensing distance and/or once the cleaning agent dispenser 60 is activated through an exchange of signals. The dispensing distance may be, for example, the arm-length of the average person (such as three feet), or any other distance beyond which the HCW 150 would not be able to obtain cleaning agent from the cleaning agent dispenser 60. Referring to FIG. 8, the cleaning agent dispenser 60 may send a dispenser line-of-sight signal (such as an IR signal represented by the black arrow) for detection by the badge 50, the dispenser IR signal including information that uniquely identifies the dispenser 60. The badge 50 may then send a second non-line-of-sight signal (such as a RF signal represented by the waves originating from the badge 50 and propagating in the direction of dispenser 60) to the dispenser 60, the second RF signal including information that uniquely identifies the HCW 150. The second RF signal of badge 50 preferably includes (in its payload) the dispenser-identifying information so that other devices receiving the second RF signal may choose not to act on it. The dispenser 60 may then send a dispenser non-line-of-sight signal (such as a RF signal represented by the waves originating from the dispenser 60 and propagating toward the room monitor 20) to the room monitor 20, the dispenser RF signal including information that uniquely identifies the HCW 150, and preferably also including information that uniquely identifies the dispenser 60. The room monitor 20 may in this way record that cleaning agent was dispensed from a given dispenser 60 by the HCW 150 at a particular time.

The room monitor 20 may detect entry by the HCW 150 into the contact zone 120, into the caution zone 130, or between contact subzones 122, 124, 126, 128, such as through motion tracking. The room monitor 20 may, for example, detect that the HCW 150 has entered the contact zone 120 or the caution zone 130. When the contact and/or caution zones 120, 130 are entered, the room monitor 20 may determine whether cleaning agent was dispensed from the cleaning agent dispenser 60 before entry of the HCW 150 into the zone. The room monitor 20 may identify and record a caution event if the cleaning agent was not dispensed from the cleaning agent dispenser 60 a time before entry of the HCW 150 into the caution zone 130. A cautionary alert may be communicated to the HCW 150 if the caution event is identified. For example, the room monitor 20 may activate a yellow light viewable by the HCW 150; sound a noise; and/or vibrate the badge 50 of HCW 150.

The room monitor 20 may also identify and record a noncompliance event if the cleaning agent was not dispensed from the cleaning agent dispenser 60 a time before entry of the HCW 150 into the contact zone 120. The system 10 may also be given hygiene protocol parameters requiring, for example, that the HCW 150 dispense cleaning agent from the dispenser 60 each time the HCW 150 exits and reenters the caution zone 130, or each time the HCW 150 moves from one contact subzone 122, 124, 126, 128 to another contact subzone 122, 124, 126, 128, to be in compliance. A noncompliance alert may be communicated to the HCW 150 as a result of the noncompliance event. The noncompliance alert may include, for example, an audiovisual or tactile alert intended to warn the HCW 150 that he or she has not recently cleaned his or her hands, such as a flashing red light viewable by the HCW 150, an audible alert, and/or a vibrating badge 50. The noncompliance alert preferably has a higher intensity than the cautionary alert in order to suggest to the HCW 150 a greater urgency.

The system 10 provides many features and advantages in automating the process of monitoring patient safety and allowing for the constant or regular monitoring of compliance with hygiene (such as the WHO 5 Moments for Hand Hygiene) or other guidelines. Using object recognition, the system 10 may automatically identify the objects near which patients 160 are often found (such as a bed 110 or a recliner). The system 10 may define various zones around objects to enhance the ability of the system 10 to more appropriately respond to HCWs 150 and patients 160 moving into and out of the defined zones. The system 10 tracks the movements of persons and equipment in the area 100 being monitored so that appropriate actions (such as alerts and notifications) may be taken. By tracking the movements of HCWs 150 around equipment, zones 120, 130, and subzones (such as 122, 124, 126, 128), the system 10 not only promotes hand hygiene by HCWs 150 approaching patients 160, but by HCWs 150 approaching or contacting different portions of a patient's 160 body or various equipment around the patient 160 and in the area 100 being monitored. Additionally, badges 40 on ambulatory patients help with the monitoring of patients 160 beyond the patient bed 110 or area 100.

Emitting the monitor line-of-sight signal (such as the IR radiation used to flood at least a portion of the area 100) into the area 100 provides noteworthy advantages. Infrared radiation is limited in range to line-of-sight and multipath transmission, helping confine the IR signals to the area 100 being monitored. The signals do not penetrate walls, but rather tend to bounce off walls without being absorbed by them, making them more reliable. Infrared light does not fall within the visible spectrum, and can thus be used to monitor the area 100 in the dark without disturbing patients 160. Infrared receivers (as incorporated in the badges 40, 50) can be very low power, prolonging the battery life of the badges 40, 50 carried by HCWs 150 and patients 160. Emitting IR signals is moreover relatively low-cost. Further, the system 10 preferably uses low-power RF to decrease interference with other equipment in the patient's 160 surroundings.

The system 10 may automatically detect and record a high number of observations on a 24/7 basis. As a result, the statistical accuracy of the system is enhanced because of the number of inaccurate or outlier observations that may be discarded during monitoring without losing reliability. Also, because thousands of events may be observed by the system per hour, the detection of interactions (among persons and equipment of interest) is greatly enhanced. Additionally, the various components of the system may help verify the observations of other components, and together provide greater accuracy than provided by a more limited system.

The system 10 also provides the ability to track HCWs 150 who are not confined to one area but instead may see patients in many different areas 100 (such as different wings of a hospital). Such a non-confined HCW 150 may have a great potential to spread disease, especially if the HCW 150 is cavalier about hygiene guidelines. The system 10 enables outbreak analysis by helping track the pathways of infection. Moreover, the system 10 provides for custom-configured reports to be used by ICPs or other authorized personnel.

Further advantages and features of the invention will be apparent from the remainder of this document in conjunction with the associated drawings.

### BRIEF DESCRIPTION OF THE DRAWINGS

FIG. 1 is a diagram of exemplary components that may be used to implement an exemplary method and system of the present invention;

FIG. 2 is a flowchart showing exemplary steps in the method and system of FIG. 1;

FIG. 3 is a diagram of modules that may be used as part of an exemplary vision system in the method and system of FIG. 1;

FIG. 4 depicts exemplary components that may be incorporated in the room monitor of FIG. 1;

FIG. 5 depicts exemplary components that may be incorporated in healthcare worker or patient badges of FIG. 1;

FIG. 6 depicts exemplary components that may be incorporated in the cleaning agent dispenser of FIG. 1;

FIG. 7 depicts the signals that may be exchanged in a healthcare worker identity detection;

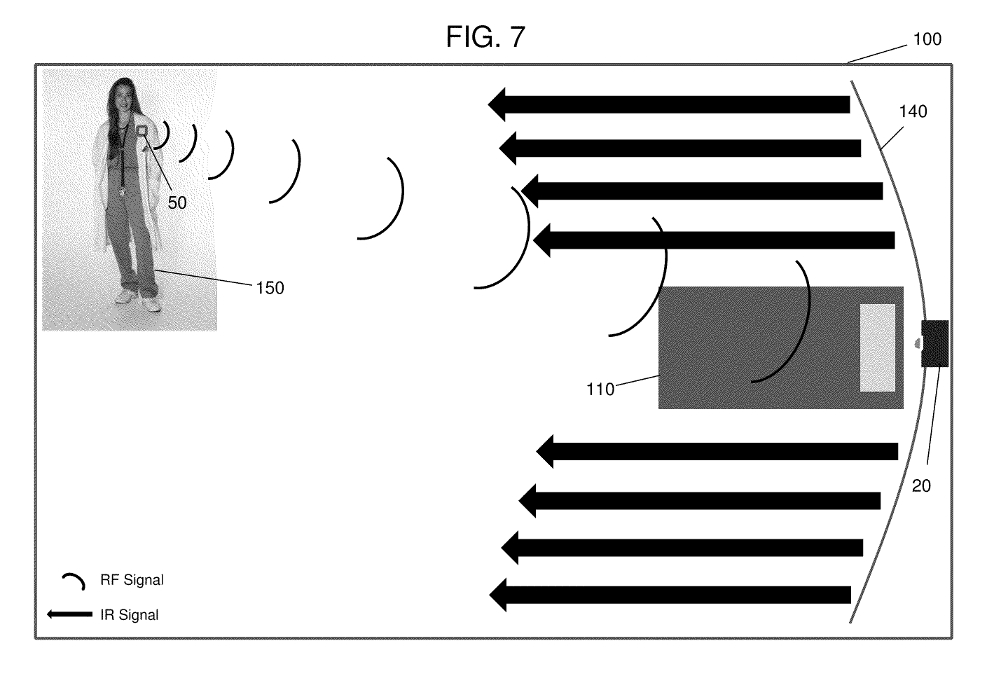

FIG. 8 depicts the signals that may be exchanged in a healthcare worker cleaning event confirmation;

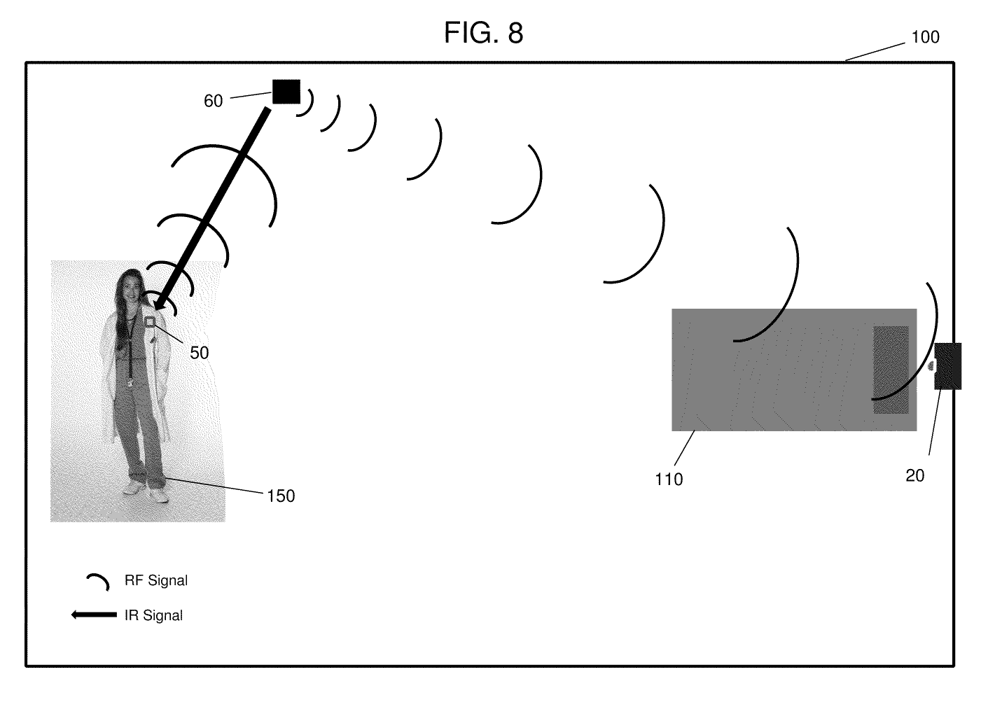

FIG. 9 depicts an exemplary vision tracking component of the room monitor of FIG. 1;

FIG. 10 depicts an exemplary image buffer of a capture block of the room monitor of FIG. 1;

FIGS. 11A and 11B depict two foot location mapping planes generated by an exemplary Contact Zone Infraction module of the vision system of the room monitor of FIG. 1;

FIG. 12 shows a person with his foot lying close to a bed and his hand making contact with the bed, as detected by the Contact Zone Infraction module of the room monitor of FIG. 1;

FIG. 13 depicts the use of vertical projections to form tight boundary around a HCW's torso, as detected by the Contact Zone Infraction module of the room monitor of FIG. 1; and

FIG. 14 depicts the use of horizontal projections to locate a HCW's arm, as detected by the Contact Zone Infraction module of the room monitor of FIG. 1.

### DETAILED DESCRIPTION OF PREFERRED VERSIONS OF THE INVENTION

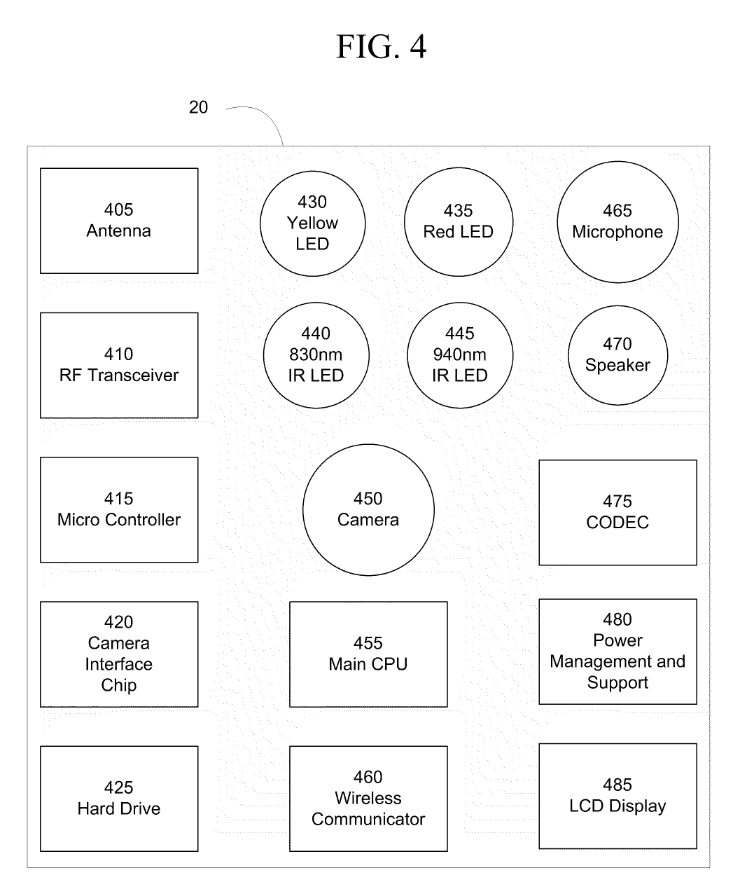

Continuing the discussion in the Summary of the Invention section, and referring to FIG. 4, the room monitor 20 used to monitor the area 100 may include an antenna 405, an RF transceiver 410 (which may operate in the industrial, scientific and medical (“ISM”) radio band), a micro controller 415 (which may control, for example, the LEDs discussed below), a camera interface chip 420 (which interfaces with the camera and may be controlled by the micro controller 415), a hard drive 425 (which may store, for example, recorded data and/or instructions to be executed by the room monitor 20), a yellow (visible) LED 430, a red (visible) LED 435, an 830 nm IR LED 440 (for illumination), a 940 nm IR LED 445 (for communication), a camera 450 (operating, for example, in the visible and near-infrared spectra), a main central processing unit (“CPU”) 455 (which may include a processor and an operating system (“OS”) for controlling the room monitor 20), a wireless communicator 460 (which may use Wi-Fi protocols to communicate with the server 70), a microphone 465, a speaker 470, a CODEC unit 475 (for compressing/decompressing video frames), a power management and support unit 480 (for monitoring power usage), and a liquid crystal display (“LCD”) screen 485 (for displaying text, images, and video, or otherwise providing information of interest).

One or more of the above room monitor 20 units may be combined into a single component, and other units may be added or taken away from the above list. For example, a TI (Texas Instruments, Inc., Dallas, Tex., U.S.A.) CC430 may be used to provide the functionality of the RF transceiver 410 and the micro controller 415. The TI CC430 is an ultra-low power MSP430 micro controller with the TI CC1100 ISM band transceiver integrated on the chip. Also, an Alcor AU3820 (Alcor Micro Corp., Taiwan) may be used to provide the functionality of the camera interface chip 420. Additionally, the vision system of the room monitor 20 may use the camera 450 to capture frames (in the visible and infrared spectra) and the main CPU 455 to perform video analytics (see discussion below). It is noted that not all of these components are required for a functioning room monitor 20, and other components may be added to provide other functionality.

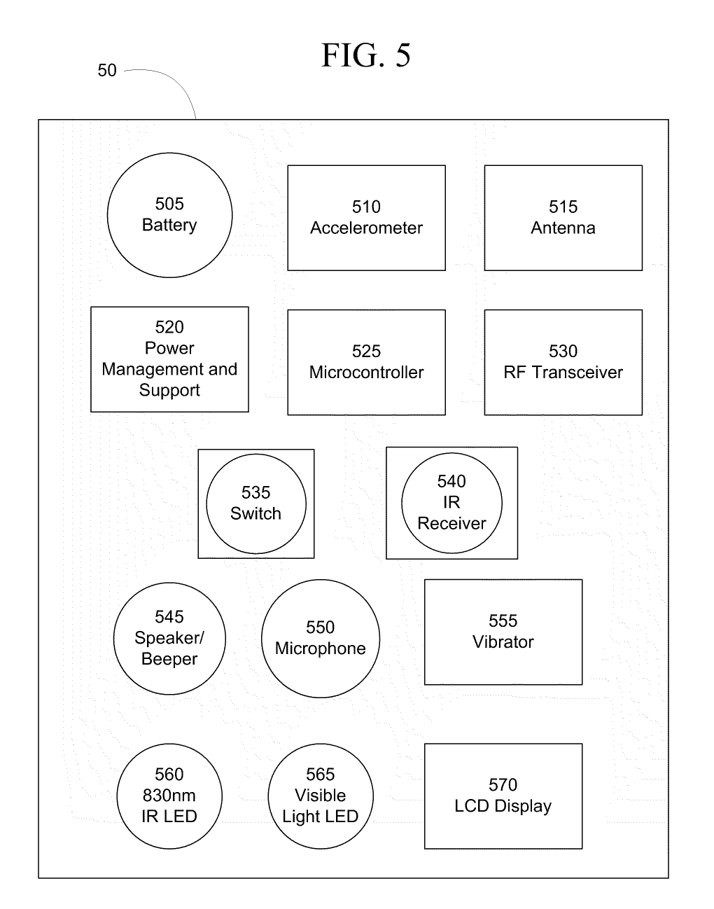

Referring to FIG. 5, the HCW badge 50 (and/or the patient badge 40) may include a battery 505, an accelerometer 510 (which may detect whether a HCW or patient is falling, standing up, or otherwise changing positions), an antenna 515, a power management and support unit 520 (for monitoring the condition of the battery), a micro controller 525 (which may control, for example, when the badge enters a “sleep mode” to conserve battery, and other components), an RF transceiver 530, a switch 535 (which may, for example, serve as a “help” call button, initiate communication with others, respond to calls for communication from others, or alert others in case attention is desired), an IR receiver 540, a speaker/beeper 545, a microphone 550 (with the speaker 545, enabling two-way communication, and allowing the HCW 150 to communicate with, for example, a nursing station or security personnel), a vibrator 555 (to help draw the attention of the HCW 150 or otherwise inform and communicate), an 830 nm IR LED 560 (which may be activated via an activation command received from the room monitor 20 in order to identify the HCW 150, as discussed elsewhere), a visible light LED 565, and an LCD screen 570.

The visible light LED 565 of badges 40, 50 may be used to indicate various modes or conditions, such as a green light indicating “I have clean hands” as the HCW 150 approaches the patient 160, or a flashing light to indicate that the badge 50 has a “very low battery charge.” The LCD screen 570 of badge 50 (and/or patient badge 40 if incorporated into the patient badge 40) may be used to display various additional information. For example, LCD screen 570 may be used to display a status, such as the “FALLEN” on badge 40 to indicate that the accelerometer 510 has detected readings commensurate with a fall so that HCWs 150 approaching the patient 160 may be more informed about the patient 160's well-being. The LCD display 570 may provide other information related to the state, condition, or location of the patient 160 or system 10, such as information on badge 50 indicating the room number in which a fall has been detected so that the HCW 150 may know where he or she is needed. It is noted that not all of these components are required for a functioning badge 50, and other components may be added to provide other functionality.

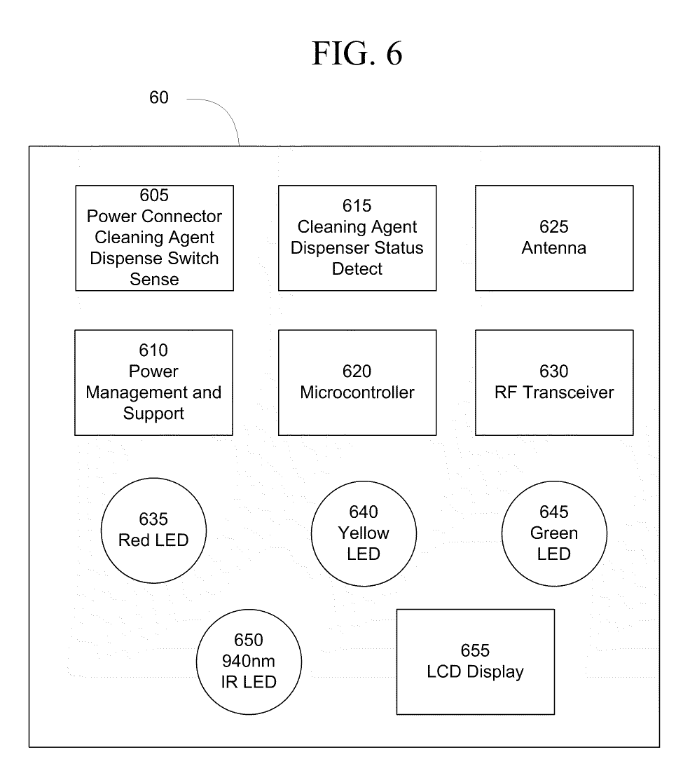

Referring to FIG. 6, the dispenser 60 may include a power connector cleaning agent dispense switch sense 605 (which may detect that cleaning agent has been dispensed), a power management and support unit 610, a cleaning agent dispenser status detect 615 (which may track whether the level of cleaning agent in the dispenser 60 is low or whether the dispenser 60 is otherwise functioning properly), a micro controller 620 (which may control the LEDs or the RF transceiver), an antenna 625, an RF transceiver 630 (which may operate in the ISM radio band), a red (visible) LED 635 (which may indicate a malfunction or that hand hygiene was not properly recorded for the HCW 150), a yellow (visible) LED 640 (which may be activated when the HWC 150 has dispensed gel to indicate that the dispenser 60 is sending its ID to the badge 50 and is waiting for the badge 50 to respond that it has received the dispenser's 60 signal), a green (visible) LED 645 (which may indicate that the dispenser 60 is ready for use, or that the HCW 150 has received cleaning agent and the dispenser 60 and/or the room monitor 20 is aware of the “clean” HCW's 150 identity), a 940 nm IR LED 650 (which may be used to communicate with badge 50, as discussed elsewhere), and an LCD screen 655 (for displaying, for example, the name of the HCW 150 obtaining cleaning agent, displaying a countdown (discussed below), messages to encourage proper hand hygiene when the HCW 150 is in the vicinity of the dispenser 60, and other messages such as “your badge battery is low” or “you are doing a great job”). It is noted that not all of these components are required for a functioning dispenser 60, and other components may be added to provide other functionality.

The room monitor 20 (or the camera 450 if the camera 450 is separate from the room monitor 20) is preferably affixed to the wall where the patient 160 is to be positioned (for example, over the patient bed 110), or it may extend from the ceiling or another structure. To enhance the vantage of the camera 450 over the area 100, the room monitor 20 may be positioned at a height (for example, six to ten feet off the floor, or preferably about 7.5 feet off the floor) that provides the camera 450 with an unimpeded view of the area 100, its entrances/exits 170, and the regions of interest (such as the patient bed 110 and a recliner). The room monitor 20 may be pivotable relative to the mechanism used to mount it to the structure so that the FOV 140 can be adjustable.

Once installed, the room monitor 20 may be calibrated so that relative distances in the FOV 140 are known. Alternatively or additionally, the system 10 may self-calibrate by, for example, recognizing objects of known or standard dimensions (such as a standard hospital bed 110 or an object added within the FOV 140 for calibration purposes). Different parts of the area 100 may be modeled using different planes to account for how tall (on average) people appear at different positions in the camera FOV. Based on how tall a person is expected to be at a certain point it can be predicted where his/her foot lies given the location of the portion/part of the body that is visible to the vision system.

The room monitor 20 may be in communication with a server 70 which is remote (that is, out of the area 100) or local (within the area) through wired or wireless communication protocols. The server 70 may in turn be in communication with multiple room monitors 20 located, for example, throughout the areas/rooms of a healthcare facility. The server 70 and the room monitor 20 may be in constant communication, or they may communicate intermittently (for example, at regular intervals or as necessary). The hospital administrator or ICP may interact with the server 70 to provide the room monitor 20 with particular instructions. The monitoring parameters of one, multiple, or all room monitors 20 are preferably customizable such that, for example, the stringency of the automated monitoring is adjustable. For example, periods of time that may elapse between the dispensing of cleaning agent and entering various zones and subzones, and the radii used to define zones and subzones are preferably customizable. The server 70 may output 80 reports and other information based on the data captured by the system 10. Real-time alerting may also be provided such that, for example, when a HCW 150 falls below a certain threshold in hand hygiene compliance (say, below 90 percent), one or more actions can be taken (such as alerting the HCW 150, notifying an administrator, or de-authorizing the HCW 150 from patient contact or from particular areas 100.

The system 10 may include the step of determining whether the cleaning agent is dispensed from the cleaning agent dispenser 60 while the HCW 150 is within the dispensing distance of the cleaning agent dispenser 60. The dispenser 60 may remain in a low-power state to conserve energy until activated by, for example, pressing a button. The dispenser 60 may be activated by other means, such as using motion detection. Requiring activation of the dispenser 60 through physical means (such as pressing a button or through motion detection) can help ensure that the HCW 150 is within the dispensing distance of the dispenser 60. Alternatively or additionally, if the cleaning agent dispenser 60 is within the FOV 140 of the room monitor 20, the position of the HCW 150 relative to the dispenser 60 can be determined visually (using, for example, object recognition of the dispenser 60 and motion tracking of the HCW 150). Further, the dispenser 60 IR signal can be emitted (having, for example, a targeted trajectory or limited signal strength) such that the badge 50 of HCW 150 cannot detect the dispenser IR signal unless the HCW 150 is within the dispensing distance. Furthermore, activation of the dispenser 60 may initiate an activation of the IR LED of badge 50, allowing the room monitor 20 to temporally and positionally associate the detected IR pulse with the HCW 150 near the dispenser 60 (as located, for example, in the FOV 140) in order to verify the identity and position of HCW 150.

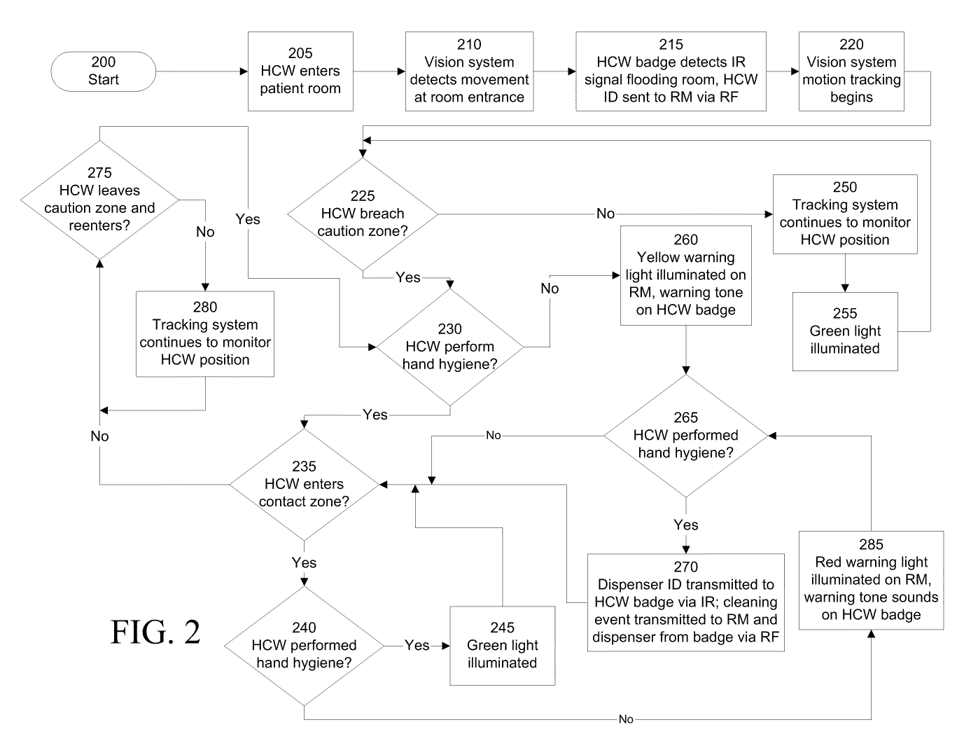

Referring to FIG. 2, a potential sequence of events in the method and the operation of the system begins (200) with a HCW 150 entering the area 100 (here, the patient room) being monitored (205). (It is noted that flowchart “steps” of FIG. 2 are placed in parentheses in the following discussion for convenience, and room monitor 20 is abbreviated as “RM” in FIG. 2.) The vision system of the room monitor 20 monitors an entrance 170 to the area 100 for movements, and detects that a tripwire 180 has been breached (210). The vision system preferably tracks the direction and rate of motion so that it may better determine, for example, whether the HCW 150 is entering the room, exiting the room, or turning around and leaving without staying in the room. The badge of HCW 150 detects the line-of-sight communication signal (for example, IR light, having a wavelength of 940 nm) flooding the area 100, and the badge 50 sends its identifying information to the room monitor 20 via a non-line-of-sight signal (for example, a low-power RF signal) (215). The vision system then tracks the motion of HCW 150 through the area 100 being monitored (220). When a HCW 150 or patient 160, for example, is being tracked, a motion tracker may be used to match motion “blobs” from frame to frame when they are moving. When the person is stationary, features (points of interest like buttons, necklaces, etc.) on the person can be matched from frame to frame to keep track of their location.

If the HCW 150 does not breach the caution zone 130 (225), the tracking system of the room monitor 20 continues to monitor the position of the HCW 150 (250), and a green light is illuminated to represent that the patient's 160 surroundings are not being breached by an unclean HCW 150 (255). If the room monitor 20 detects that the HCW 150 breaches the perimeter (that is, trips a tripwire) of the caution zone 130 (225), the room monitor 20 determines whether the HCW 140 has engaged in hand hygiene (230). Hand hygiene may be inferred, for example, from the activation of dispenser 60 prior to the breach of the caution zone 130. If hand hygiene was not performed, a cautionary alert is communicated in the form of, for example, a yellow warning light being illuminated on the room monitor 20, and a warning tone being sounded on the badge 50 of the HCW 150 (260). It may then be determined whether cleaning agent is dispensed from dispenser 60 by the HCW 150 in order to perform hand hygiene (265). If yes, the dispenser 60 emits its ID to the badge 50 via an IR signal, and the badge 50 detects the IR signal and transmits an RF signal to the dispenser 60 and the room monitor 20 to indicate that hand hygiene has taken place (270). If no, the room monitor 20 continues to monitor whether the HCW 150 enters the contact zone 120 (235). Alternatively, the badge 50 may transmit the RF signal at a lower signal strength so that it only reaches the dispenser 60 and not the room monitor 20 in order to conserve battery; the dispenser 60 may then transmit an RF signal to the room monitor 20 to indicate that hand hygiene has taken place. If hand hygiene has been performed before the HCW 150 breaches the caution zone 130, the green light on the room monitor 20 may remain illuminated.

The room monitor 20 continues tracking the HCW 150 to determine whether the HCW 150 enters the contact zone 120 (235). If the contact zone 120 is breached, and hand hygiene has been performed (240), the green light is illuminated (or remains illuminated) on the room monitor 20 (245). If the HCW 150 does not enter the contact zone, the room monitor 20 tracks whether the HCW 150 leaves and reenters the caution zone 130 (275). If not, the tracking system continues to monitor the HCW 150 to determine whether the HCW 150 enters the contact zone 120 (280). If the HCW 150 does leave and reenter the caution zone 130, it is determined again whether the HCW 150 has performed hand hygiene (230), and if not, the yellow warning light is illuminated (260). If the HCW 150 enters the contact zone 120, and the room monitor 20 determines that hand hygiene has not been performed (240), the noncompliance alert is communicated in the form of a red warning light being illuminated on the room monitor 20, and a warning tone being sounded on the badge 50 of the HCW 150 (285).

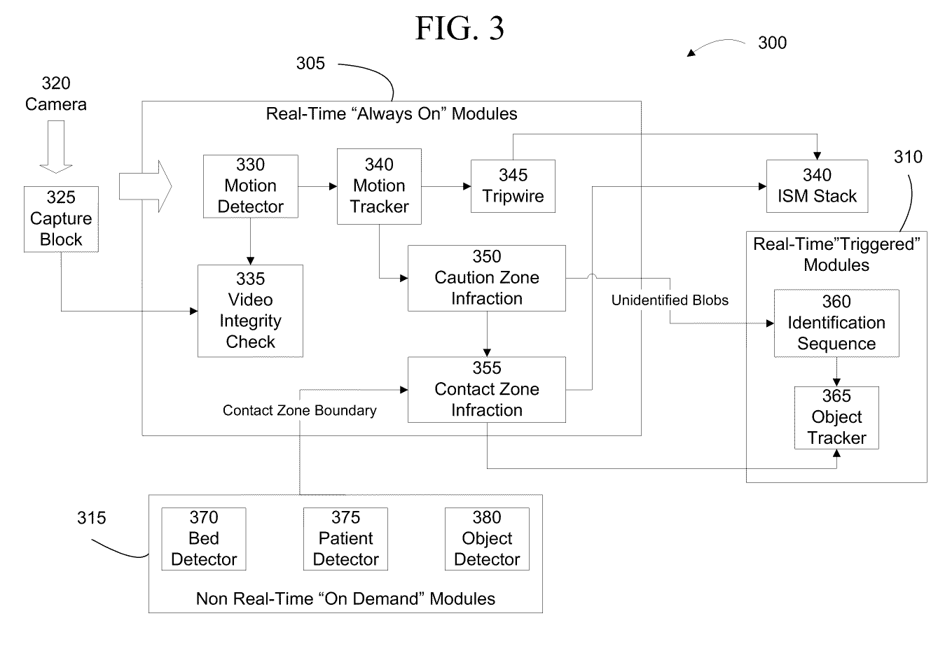

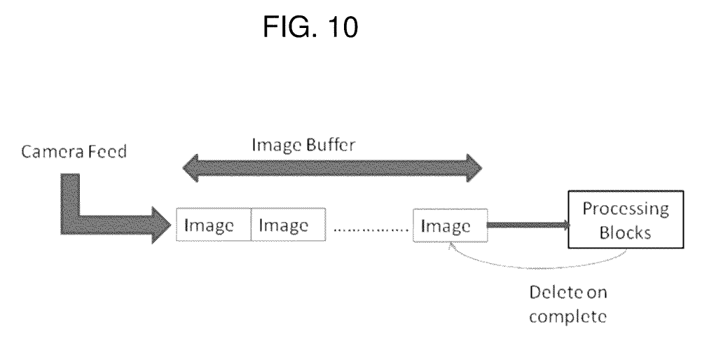

Referring to FIG. 3, the vision system of the room monitor 20 preferably includes a camera 320 that can capture still images and video at a variable rate. The room monitor 20 may record (and locally store) images/video for subsequent transmission to the server 70, or it may stream the images/video to the server 70 as it is captured. A capture block 325 may query the camera 320 for a video frame periodically, the duration between queries (frame rate) being preferably configurable, varying between 1 Hz to 30 Hz (that is, 1 to 30 frames per second) or higher. As shown in FIG. 10, the capture block 325 may maintain a video/image buffer in the form of a first in first out (“FIFO”) queue. Once a frame has been passed to a video analytic system 300 for processing, the video buffer may by default delete the frame from the queue (or it may be saved for subsequent use). If the camera's 320 capture resolution is not the same as the native resolution of the video analytic system 300 (for example, 376 by 240 pixels) the capture block 325 may resize the input images before adding them to the video buffer.

Returning to FIG. 3, the video analytic system 300 includes various conceptual modules, the functions of which may be implemented using hardware and/or software. The video analytic system 300 may be divided into at least three types of modules. First, real-time “always on” (“RTAO”) modules 305 may process every frame of video in real-time, creating the events that activate triggered modules. Second, real-rime “triggered” (“RTT”) modules 310 may run only when they are activated by RTAO modules 305. When RTT modules 310 are active, they may process all input video frames in real time. Third, non real-time “on demand” (“NRTOD”) modules 315 may generally be invoked on a periodic basis and may process short bursts of video.

A Motion Detector module 330 (an RTAO module 305) may begin by processing the video frame at the front of the queue to determine which pixels in the image are moving. The Motion Detector 330 may output a motion mask; or a binary image with ones representing moving pixels and zeros representing stationary pixels. In order to maintain efficiency, the system 10 preferably processes input images within 30 milliseconds, splitting its processing stream into multiple threads if multiple processing cores are present. The Motion Detector 330 also preferably performs morphological operations on the motion mask to filter out pixel noise and create well-defined outlines that can more easily be segmented. The Motion Detector 330 may perform background subtraction to determine which image pixels are moving. Background subtraction may be performed, for example, based on the paper “An Improved Adaptive Background Mixture Model for Real-time Tracking with Shadow Detection” by P. KaewTraKulPong and R. Bowden, In Proc. 2nd European Workshop on Advanced Video Based Surveillance Systems, AVBS01, September 2001, the entirety of which is incorporated by reference herein (and briefly summarized here).

Consider a video stream from a stationary (or stabilized) camera. Let x_{N} represent the value of a certain pixel at time N. The probability that a certain pixel has a value of xₙ, at time N can be written as:

$$p ( {x}_{N} ) = {\sum }_{j = 1}^{K} {w}_{j} η ( {x}_{N} ; {θ}_{j} ) \qquad Eq . 1$$

where w_{K} is the parameter weight of the k^{th} Gaussian component.

Different Gaussians are assumed to represent different colors. The weight parameters of the mixture represent the time proportions that those colors stay in the scene. The background components are determined by assuming that the background contains B highest probable colors. The probable background colors are the ones which stay longer and more static. Static single-color objects trend to form tight clusters in the color space while moving ones form wider clusters due to different reflecting surfaces during the movement. The measure of this is called the fitness value. To allow the model to adapt to changes in illumination and run in real-time, an update scheme was applied. It is based upon selective updating. Every new pixel value is checked against existing model components in order of fitness. The first matched model component will be updated. If it finds no match, a new Gaussian component will be added with the mean at that point and a large covariance matrix and a small value of weighting parameter.

η(X;θₖ) is the normal distribution of the k^{th} component represented by

$$η ( x ; {θ}_{k} ) = η ( x ; {μ}_{k} , {\sum }_{k} ) = \frac{1}{{( 2 π )}^{\frac{D}{2}} {\vert {\sum }_{k} \vert}^{\frac{1}{2}}} {e}^{- \frac{1}{2} {( x - {μ}_{k} )}^{T} {\sum }_{k}^{- 1} ( x - {μ}_{k} )} . \qquad Eq . 2$$

where μₖ is the mean and Σ_{K} is the covariance of the k^{th} component. The K distributions are ordered based on a fitness value (W_{K}/σ_{K}) and the first B distributions are used as a model of the background of the scene (non moving components). Background subtraction is performed by marking a foreground pixel as any pixel that is more than a certain threshold T away from any of the B distributions. It is noted, however, that any motion detection technique implementing hardware and/or software may be used.

A Video Integrity Check module 335 (an RTAO module 305) may use the current frame (that is, the frame at the front of the video buffer) and the motion mask to determine whether there are any errors or video quality problems. This module preferably detects such conditions as whether (i) the camera 320 is providing blank frames; (ii) the images are “stuck” (that is, the images are not changing from frame to frame); (iii) the images are washed out by excess light; (iv) the images are too dark; (v) there is a longer than expected delay following the frame query; (vi) the camera 320 is out of focus; and/or (vii) the camera has been moved. The Video Integrity Check module 335 may attempt to rectify the problem by resetting the camera 320 to a known preset. If resetting the camera 320 does not correct the issue, the module may notify the server 70 that the video quality may be insufficient for the vision system to function.

A Motion Tracker module 340 (an RTAO module 305) uses the motion mask created by the Motion Detector 330 to segment the video frame into a set of moving objects. This module may perform a connected component analysis of the contours obtained by tracing the outlines (that is, the transition points between the zeros and ones) in the motion mask. The Motion Tracker 340 may then match moving objects with objects observed in previous video frames using criteria such as object height and width, object aspect ratio, and object location. The Motion Tracker 340 may also maintain a saliency measure that indicates how coherently an object is moving. To enhance efficiency, moving objects from one frame may only be compared with objects that are found in, for example, a 50-pixel distance in the next frame. It may be assumed, for example, that objects that move more than 50 pixels between two frames could not represent a person, and the object in the frame may be re-categorized or ignored. Once an object in the current frame is matched with an existing object, it is preferably not matched with another object so that ambiguous tracks are avoided and the number of required comparisons reduced. The Motion Tracker 340 preferably keeps track of all moving objects as long as they are present in the FOV 140. It is noted that any motion tracking technique implementing hardware and/or software may be used.

A Tripwire module 345 (an RTAO module 305) may monitor an object being tracked by the Motion Tracker 340 to determine when it crosses a predetermined line moving in any direction (for example, entering or exiting the patient room or approaching an object or defined zone). This module 345 determines when an object makes contact with a tripwire using, for example, a simple polygon overlap metric. Once an object approaches or contacts the tripwire, the Tripwire module 345 may determine whether the object is moving at an appropriate rate (using the direction of motion and saliency values from the Motion Tracker 340) to breach the tripwire and, if so, may assume that the tripwire has been breached.

The Tripwire module 345 may notify an Identification Sequence module 360 (an RTT module 310) when a tripwire has been breached, preferably providing information as to which direction the object is moving (for example, in or out of the room). If the Tripwire module 345 is unsure of the direction of motion it will notify the Identification Sequence 360 that there is activity at the entry portal 170 but that the direction of motion is unclear so that the Identification Sequence 360 can act accordingly. The Identification Sequence 360 may maintain a stack 340 with a list of all objects (for example, HCWs 150, patients 160, and equipment) in the room. It preferably updates the stack 340 when the Tripwire module 345 determines that an object has either left or entered the room.

The Identification Sequence 360 may administer communication between the vision system, the stack 340, and badges 50. It may additionally correlate the silhouettes of objects that have breached the caution zone 130 with badges 50. For example, the Identification Sequence 360 may illuminate the IR LEDs on badges 50 in the room in a round-robin fashion. The Identification Sequence 360 may retry after a specified interval if it is unable to locate the HCW 150 carrying a badge 50. If the object's silhouette breaches the caution zone 130, the object is added to an Object Tracker module 365 (discussed below) and is tracked until it can be identified.

A Caution Zone Infraction module 350 (an RTAO module 305) may determine when an object breaches the caution zone 130 boundary (that buffers the contact zone 120) and thus could possibly make contact with the patient 160 or the bed 110. The module 350 may use an area-of-overlap metric to determine whether an object has made contact with the caution zone 130. To lower false detections, the module 350 may by default not identify a breach unless the object makes contact with the caution zone 130 for an extended period of time (for example, one second or greater).

The Caution Zone Infraction module 350 may then alert the Identification Sequence 360 to correlate a HCW 150 badge 50 with the object that triggered the breach. The Identification Sequence module 360 may query the stack 340 for HCWs 150 in the room and illuminate the IR LED on each badge 50 round-robin until a badge 50 can be correlated with the object that has just breached the caution zone 130. It is noteworthy that the caution zone 130 may also be used as a buffer zone for multiple-contact detection, such that when a HCW 150 makes contact with a patient 160 he/she has to sanitize his/her hands again if he/she were to leave and reenter the caution zone 130. This enhances the ability of the system 10 to implement the “5 Moments for Hand Hygiene” (such as Moments (3) and (5)) allowing, for example, an administrator or ICP to configure the system 10 to alert the HCW 150 that they must re-sanitize if they leave and reenter the caution zone 130.

A Contact Zone Infraction module 355 (an RTAO module 305) may determine when an object breaches the boundary of the contact zone 120, as defined by the output of a Bed Detector 370 or Patient Detector 375 (further discussed below), which may detect the boundary of the bed 110 or patient 160 using, for example, object recognition. First, the module 355 may calculate the angle of incidence between the object and the contact zone 120 to determine if the object (person) could be standing at a location where parts of the object (for example, the person's feet) are occluded by the caution zone itself. The module 355 predicts the location of the person's foot using the height calibration information captured during system 10 deployment to help determine if a person is standing close enough to a zone to actually make contact. The height calibration tool models the foot locations (as a function of where the person's head is seen) as a set of discrete planes, each with a different head-location to foot-location mapping function. This allows the system 10 to account for large changes in depth within the scene, and also for lens distortion.

The height calibration tool may use a combination of nearest neighbor interpolation and the solution for an overdetermined linear system to compute the foot locations using samples captured during the calibration process. Footage of a person walking around the room may be sampled post-installation to provide an input to the height calibration tool, and an installer may manually mark the head and foot location before the tool calculates the foot location mapping. This can be simply described as:

Foot Location(x,y)=Function(Head Location)for each discrete depth plane Eq.3

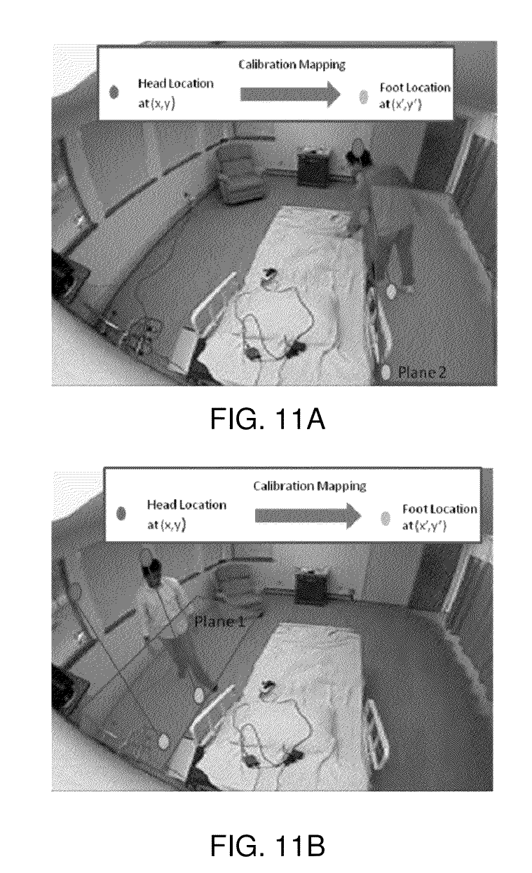

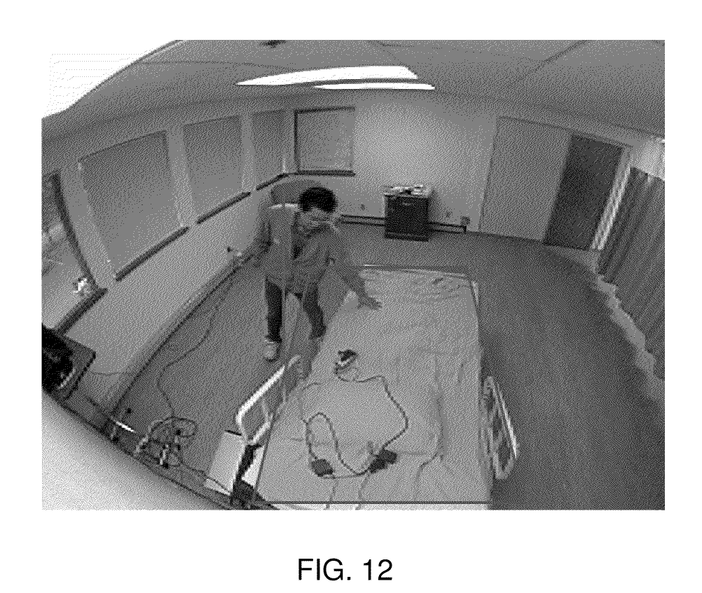

Two discrete foot location mapping planes are shown in FIGS. 11A and 11B. It is noted that the two planes in the figure above vary with camera distortion (that is, in Plane 1 torsos are angled differently than in Plane 2). The system combines a set of such discrete planes to accurately map the foot locations of objects in the room. A person is shown in FIG. 12 with his foot lying close to the bed 110 and his hand making contact with the bed.

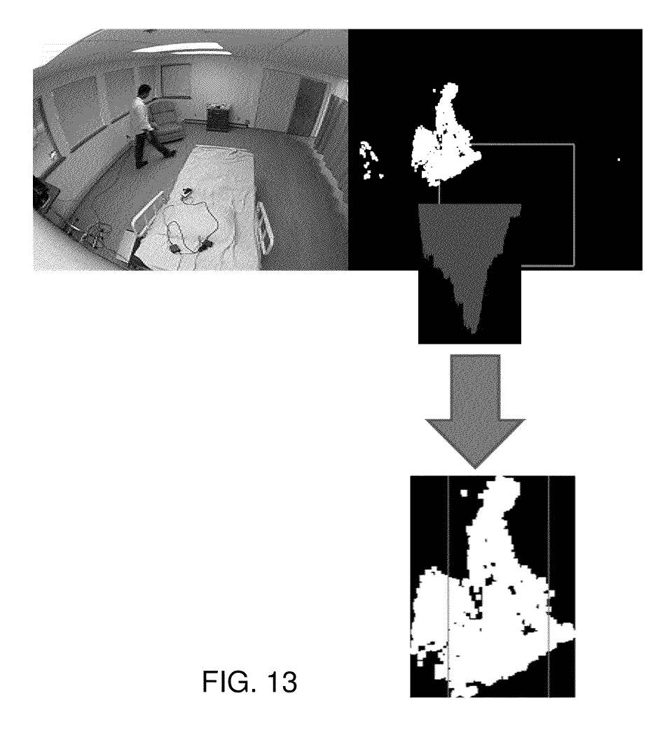

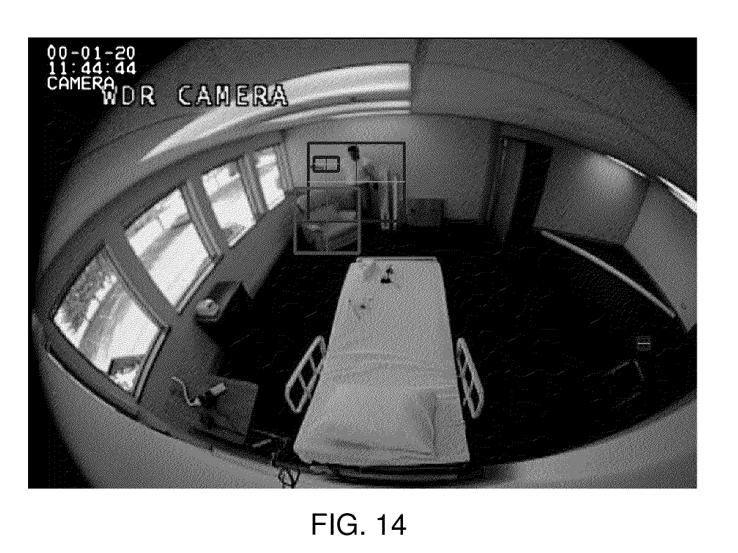

The Contact Zone Infraction module may use a combination of vertical and horizontal projection histograms to determine more accurately where a person's torso lies and where his/her hand is. For example, a vertical projection histogram can be used to form a tighter boundary around an object's torso, as shown in FIG. 13. Analogously, as shown in FIG. 14, a horizontal projection histogram may be used to more accurately determine the location of a person's arm, enhancing the accurate determination of when contact occurs. The use of histograms helps to more accurately capture when someone makes contact with the contact zone 120. Such histograms may help estimate the center-of-gravity of the silhouette of the object by, for example, identifying a person's extended arm. False positives may be reduced by, for example, distinguishing between a foot breaching the contact zone 120 (which may not mean there is actual patient contact) and an arm entering the contact zone 120 (which may have a higher likelihood of patient contact). To further lower false detections, the module 355 may by default not identify a breach unless the object makes contact with the contact zone 120 for an extended period of time (for example, one second or greater).

The Object Tracker module 365 (an RTT module 310) preferably tracks the motion of objects by using color and intensity histogram information to match moving objects from frame to frame. When a moving object becomes stationary, the module 365 tracks a set of features on a stationary object from frame to frame. The Object Tracker 365 may be tasked only with tracking objects before they make contact with the contact zone 120. This module preferably notifies the Identification Sequence 360 if it cannot track an object with a high degree of certainty. If an unknown object breaches the contact zone 120, the Object Tracker 365 may send a notification signal to the Identification Sequence 360 to identify the object. If a known HCW 150 being tracked by the Object Tracker 365 breaches the contact zone 120, a notification signal may be sent to the stack 340 to tag the HCW 150 as “known” to ensure that his/her badge 50 is not queried again, helping conserve battery life. The Object Tracker 365 may keep tabs on all HCWs 150 in the room and all unidentified objects awaiting identification.

The Bed Detector module 370 (an NRTOD module 315) determines the location and outline of a bed 110 in the FOV 140 of camera 320. This module 370 includes a bed location component, which determines the position and boundaries of a bed 110 in the FOV 140 with no prior knowledge of where the bed 110 lies. Texture detection may be combined with segmentation to detect which part of the camera's FOV is the floor, and the bed may then be detected as the, for example, largest object lying on the floor. The module also includes a location affirmation component that determines if the bed 110 is still located at the position in which it was located. If the bed 110 has moved or has been occluded, the video analytic system 300 activates the bed location component. The location affirmation component may be executed periodically and is intended to function in real time. The Bed Detector 370 is preferably implemented on a separate low priority thread to avoid backing up the processing stream.

The Patient Detector module 375 (an NRTOD module 315) may be run periodically to determine the location of a patient badge 40 and define an infraction zone around the badge. The module may use prior knowledge of relative scales from height calibration information to create an infraction zone around the patient badge 40 if the patient is stationary. If the patient 160 is moving, motion information may be used to determine the outline of the infraction zone around the badge. The module also attempts to determine the silhouette of the patient 160 by using information provided by the Motion Detector 330. The Bed Detector 370 may also be run periodically to determine the exact location and outline of the bed 110 in the video frame. The Bed, Patient, and Object Detector modules 370, 375, 380 (previously discussed) may also be invoked, for example, when the video analytic system 300 loses track of the bed 110 or the patient 160. It is noted that not all of these modules are required for a functioning vision system, and other components may be added to provide other functionality.

The badge 50 serving as the ID badge of the HCW 150 may be an active RFID device having IR communications capability. Other technologies may be used, however, such as (battery-assisted) passive RFID technology. Badges may also be provided to keep track of patients 160 or equipment (such as a patient badge 40), although some badges may have decreased functionality or power to control costs and prolong battery life. For example, HCWs 150 may be provided with durable badges 50 whereas patients 160 may be provided with disposable badges 40 having a battery life of one week.

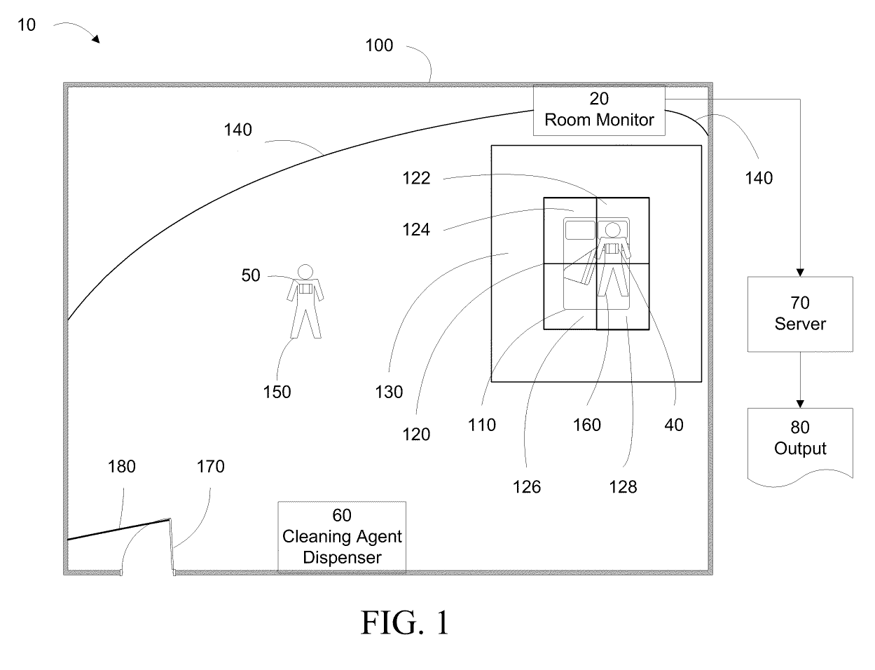

The information gathered by the components of the system 10 may be recorded, organized, and processed for reporting, auditing, real-time alerting, and other purposes. For example, reports 80 (see FIG. 1) can be generated on: the interaction of HCWs 150 with multiple patients 160; the level of compliance of the HCW 150 with hygiene protocols; the HCWs 150 with whom a patient 160 came in contact and the time/location of such contact; the mobility of a patient 160; the level of attention a patient 160 received or the time a patient 160 was left alone; the overall compliance of staff with various protocols; etc.

It is noted that the system 10 may by default be configured to give HCWs 150 the benefit of the doubt in case of uncertainty. That is, if any ambiguities need to be resolved regarding what has been detected, measured, or otherwise automatically determined regarding compliance with a given protocol, the HCW 150 may be assumed to be in compliance until noncompliance can be more unambiguously determined. This is preferably adjustable by administrators or ICPs if, for example, it is determined that erring on the side of patient safety in case of ambiguity is desirable.

Various preferred versions of the invention are shown and described above to illustrate different possible features of the invention and the varying ways in which these features may be combined. Apart from combining the different features of the foregoing versions in varying ways, other modifications are also considered to be within the scope of the invention. Following is an exemplary list of such modifications.

First, in addition to having IR and RF communications capabilities, the cleaning agent dispensers 60 may be provided with other features. For example, the gel dispensers 60 may be configured to detect and communicate the presence of certain characteristics, such as long or artificial hand nails that may be relevant to HCW 150 hygiene and patient safety. The detection of relevant characteristics may be communicated to the HCW 150 while the dispenser 60 is being used, or at some point thereafter (for example, in a regular report or via electronic communications). The characteristics may be also be logged for auditing or other purposes.

Second, in addition to monitoring compliance with hand hygiene guidelines, the system 10 may be configured to record, alert, notify, or otherwise identify other events. For example, the room monitor 20 can track whether a HCW 150 (or a patient 160, a visitor, or any person) is authorized to approach a patient 160 and alert the HCW 150 or others of unauthorized breaches of defined zones. Analogously, a piece of equipment may be monitored for its position relative to another piece of equipment based on whether one would interfere with the other. A person (or equipment) may be automatically or manually authorized, unauthorized, or reauthorized based on past compliance with protocols, level of training, role in the organization, previous experience, or various observations. Information regarding zones that may not be breached, patient-contact authorizations, and job duties may be programmed in the ID badge or they may be maintained in the room monitor 20, server 70, or elsewhere.

Third, if the patient 160 moves to the edge of his/her bed 110, sits up in his/her bed 110, begins to rise from a sitting position from the bed 110 or recliner, enters or exits one of the zones, or otherwise changes position, as determined using, for example, object recognition, motion tracking, and/or readings from an accelerometer incorporated in the badge 40 worn by the patient 160, an appropriate staff member may be notified. Also, a high-priority alert may be sent to the nearest nursing station or to all HCWs 150 nearby (such as on the same floor) to warn of this behavior, as configured by a unit manager or other authorized personnel. An enunciator may additionally be provided with the room monitor 20 to advise the patient 160 to remain where they are and inform the patient 160 that a nurse has been notified. Moreover, the readings from the accelerometer in the badge could help predict, for example, that the patient 160 is attempting to sit up or get out of bed 110, or that the patient 160 is unstable and may be about to fall (or has already fallen).

Fourth, the security of patients 160 can be further enhanced by permitting access only to authorized persons, regardless of whether the person is carrying a badge. For example, a motion recognition subsystem of the room monitor 20 may trigger an attempt to determine whether a new entrant is carrying a badge. If there is no badge, or if the badge lacks the required credentials to enter the area 100, a high-priority alert may be sent to the nearest nursing station or to hospital security. This enhances after-hours security, child-patient 160 protection, limitation on the number of visitors allowed, etc.

Fifth, the room monitor 20 may be programmed to search for any equipment in the patient room that has been “tagged” (using a system equipment tag) at a predetermined interval (for example, every 15 minutes or upon detection of motion). The server 70 may maintain a list identifying the equipment and how long it has been at a location. This allows for physical control of high-value or critical equipment resulting in improved asset utilization. The system 10 can also feed data to an equipment maintenance log to ensure regular or preventative maintenance is performed as required. Additionally, the system 10 can perform environmental monitoring using the equipment tag. For example, if the equipment needs to be maintained above or below a certain ambient temperature, or near a given humidity, the badge can detect whether the temperature or humidity has fallen outside of safe levels and communicate the unsafe condition to a specified staff member.

Sixth, to enhance quality of care, the system 10 may be configured to produce a report that summarizes the time and duration of each visit a HCW 150 makes to a patient room. This report can also include staff response time performance if the system 10 is interfaced with the nursing call system. Objective data from these reports can help a hospital or care facility achieve patient care objectives. Such a tool could help make the facility more competitive by improving patient 160 satisfaction while reducing liability exposure.

Seventh, installing the room monitor 20 in an infant nursery or neonatal ICU may help ensure that only authorized personnel are permitted near the infants. The system 10 can monitor whether, for example, a person “tailgates” a HCW 150 in order to gain access (using, for example, object recognition and motion tracking to determine that an unidentified person (for example, without a badge, or with an unauthorized badge) has entered the area 100 behind an authorized person). The system 10 can also be configured to send an alert to security when an unauthorized person attempts to leave the room with a monitored infant. Moreover, an audible alert can also be generated via a room monitor 20 enunciator to alert a sleeping patient 160, parent, or HCW 150.

Eight, the system 10 may monitor a person's movements to determine whether the person (in, for example, a nursery or ICU) has been virtually immobile for a certain period of time (say, 15 minutes). The room monitor can then flash a blue light for a time (say, three minutes) without a noise, requiring the person to press a button to deactivate the blue light and indicate that the person is awake, conscious, or otherwise alright. If the button is not pressed within the required time, the room monitor 20 enunciator may make a noise in an attempt to wake the person who may have fallen asleep. If a button is not pressed after the enunciator's alert (say, within one minute), the room monitor 20 may alert the nearest nursing station that the person in the area may have fallen asleep, lost consciousness, or otherwise become unresponsive. Analogously, if a patient 160 is sleeping, in a coma, or otherwise not conscious, the room monitor 20 can be configured to alert the nearest nursing station if the patient 160 begins to awaken or otherwise begins moving so that staff can respond accordingly and so the patient 160 can receive needed attention.

Ninth, some patients 160 may need to be quarantined or otherwise isolated due to a high risk of infection. Access to patients 160 in isolation may be limited to properly-garbed staff specializing in treating such cases. For example, the room monitor 20 may be configured to detect that a gown, hat, and mask are worn near the patient 160. Noncompliance can be recorded and reported for each staff member that fails to follow proper gowning procedures. Additionally, noncompliance may deauthorize the HCW 150 from entering other areas of the hospital or other patients 160. Further, because the gowning requirements for staff entering rooms with isolated patients 160 can be onerous, overall patient contact time by staff tends to be less than contact time with non-isolated patients 160. Such reduced contact time may negatively impact patient morale and healing time. The system 10 may monitor and report patient contact time so that isolated patients 160 are not neglected by staff.

Tenth, it is widely recognized that proper and regular patient room sanitization is necessary to reduce the spread of HAIs. The system 10 can be provided with a module configured to monitor the quality of patient room sanitization by janitorial staff members. This may be accomplished, for example, through reports that summarize the length of time spent in each room by janitorial staff as well as time spent in selected critical regions of the room. The presence and changing locations of janitorial staff may be detected as previously described. The room monitor 20 may divide an area into zones of interest, and the length of time spent in each zone by janitorial staff may be captured for subsequent processing and summarization.

Eleventh, deterministic infection case management functionality can be provided in the system 10. As the system 10 monitors the interactions and events that take place in a facility among patients 160, HCWs 150, visitors, equipment, zones/subzones, etc., such raw data is stored on the server 70 for subsequent retrieval, processing, and reporting 80. Such data can be mined to enable infection control staff to more fully understand infection origins and trends within the facility. Known infection case management may be entered into the system 10 by ICPs, and data processing algorithms may compare actual patient infection cases with prior staff interaction data from the system 10 database to determine whether there are areas of concern that warrant follow-up by infection control personnel. For example, such analysis may reveal that several patients 160 contracted a HAI while under the care of a common staff member. Historical patient infection data for the particular staff member in question may then be compared to the same data for other staff members to determine whether a statistically relevant trend can be identified. Similar analyses may yield possible room contamination issues or inadequate housekeeping as a common variable associated with the HAI case under review.

Twelfth, the vision system of the room monitor 20 may be activated to initiate video footage when one or more criteria are met. For example, when a HCW 150 under review enters the area 100 being monitored, or breaches the contact/caution zones 120, 130, the room monitor 20 may begin recording video footage for subsequent review by authorized personnel. Also, the room monitor 20 can be configured to audit the performance of a certain procedure at the care facility or by a particular HCW 150. For example, an ID badge can be provided with a given piece of diagnostic equipment or kit (say, a portable defibrillator or IV kit), and the system 10 can detect when that kit is brought near a patient 160 or is otherwise activated/opened. The room monitor 20 can then begin recording video footage around the patient 160 or equipment for such reasons as performance evaluation (for example, at the initiation of a bundle exercise). That is, the room monitor 20 can help monitor exercises by confirming the “bundle” (or set) of procedures required when the equipment or kit is being used. The room monitor 20 may be configured to record only every multiple of the procedure being performed or record procedures randomly for auditing and review. Further, the room monitor 20 can be configured to record procedures or interactions by personnel based on, for example, student or trainee status for evaluation and training purposes.

Thirteenth, although IR (for example, near infrared) and RF (for example, in the ISM band) signals may provide certain advantages, the types of signals used in the system 10 may be varied to use any electromagnetic or mechanical communications means. If electromagnetic line-of-sight and non-line-of-sight signals are used, they may be replaced by signals on the electromagnetic spectrum other than IR and RF.

Fourteenth, if the dispenser 60 dispenses a cleaning agent (such as soap) which requires a period of time to properly use, a countdown clock may be provided with the dispenser 60. The countdown clock, which may be set to a modifiable default of 20 or 30 seconds, may be displayed on the dispenser 60 (or elsewhere, such as on the room monitor 20 or badge 50) so that the HCW 150 knows to wash his or her hands for the displayed time. The room monitor 20 may monitor whether the HCW 150, for example, breaches the contact zone 120 before the countdown clock reaches zero. If so, the room monitor 20 may infer, for example, that the HCW 150 did not thoroughly clean his or her hands and that the HCW 150 is noncompliant despite the observed dispensing of cleaning agent from dispenser 60.

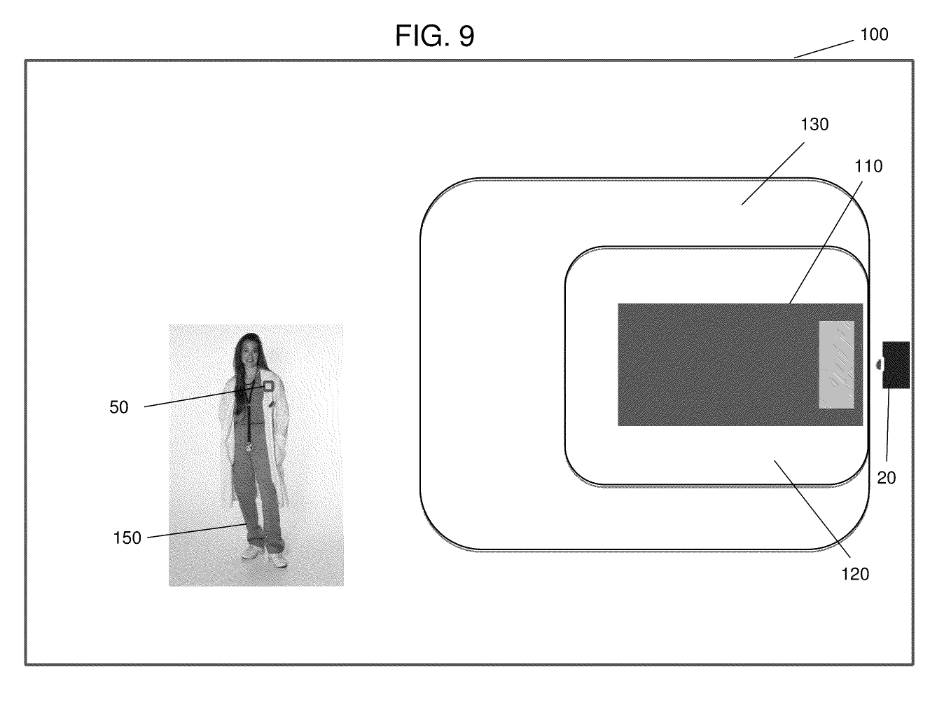

Fifteenth, although in FIGS. 1 and 9, the outlines of the contact and caution zones 120, 130 are shown as approximately rectangular, the outlines of the zones may be defined to have any geometric (for example, rectangular, polygonal, circular, oval, etc.) or non-geometric and irregular shape.

Sixteenth, although badges 40, 50 are shown to be carried by HCWs 150 and patients 160, badges may also be provided for other persons and objects, such as visitors, equipment, or any object of interest. For example, a badge may be provided with the IV kit which will initiate video footage when being used by a particular HCW 150 (as discussed above). The badge may be installed with the equipment such that a signal is emitted from the badge when the kit or other equipment is opened or otherwise activated. The signal could notify the room monitor 20 or other HCWs 150 of the badge's location and inform other components in system 10 that a particular action should be taken (such as initiating video recording or summoning security or other personnel).

Seventeenth, variable audible alerts can be used to inform the HCW 150, patient 160, or others depending on the event triggering the alert. For example, a quieter or higher-pitch “chirping” noise may be emitted from the badge 50 or room monitor 20 in case of a breach of the caution zone with unclean hands, but a louder, lower-pitch triple beep may be used to notify the HCW 150 that a patient fall has been detected or a patient fall is predicted (discussed above).

Eighteenth, although the room monitor 20 and the cleaning agent dispenser 60 are shown in FIG. 1 to be in area 100, the room monitor 20, the gel dispenser 60, or some/all of their components may be located outside the area 100.

Nineteenth, although the system 10 is shown with one room monitor 20 with one camera 450 incorporated therein, the system 10 may utilize additional room monitors 20, additional cameras 450, or other components as desired.

The invention is not intended to be limited to the preferred versions of the invention described above, but rather is intended to be limited only by the claims set out below. Thus, the invention encompasses all different versions that fall literally or equivalently within the scope of these claims.

What is claimed is:

1. A method for monitoring patient safety in an area, the area including an area monitor and a cleaning agent dispenser, the method including:
a) emitting a monitor line-of-sight signal into the area using the area monitor, the monitor line-of-sight signal including information uniquely identifying the area;
b) detecting the monitor line-of-sight signal using a badge carried by a service provider when the service provider enters the area;
c) sending a first non-line-of-sight signal from the badge to the area monitor after the service provider has entered the area, the first non-line-of-sight signal including information uniquely identifying the service provider carrying the badge;
d) detecting the first non-line-of-sight signal using the area monitor; and
e) determining whether cleaning agent is dispensed from the cleaning agent dispenser while the service provider is within a dispensing distance of the cleaning agent dispenser.

2. The method of claim 1, wherein the area monitor at least substantially saturates at least a portion of the area with the monitor line-of-sight signal.

3. The method of claim 1 further including the step of identifying the service provider who dispensed cleaning agent from the cleaning agent dispenser, wherein identifying the service provider includes the steps of:
a) sending a dispenser line-of-sight signal from the cleaning agent dispenser to the badge, the dispenser line-of-sight signal including information that uniquely identifies the dispenser;
b) sending a second non-line-of-sight signal from the badge to the dispenser, the second non-line-of-sight signal including information that uniquely identifies the service provider; and
c) sending a dispenser non-line-of-sight signal from the dispenser to an area monitor, the dispenser non-line-of-sight signal including information that uniquely identifies the service provider.

4. The method of claim 1 further including the steps of:
a) performing object recognition of an object in the area using an area monitor, the area monitor being located in the area; and
b) defining a contact zone based on proximity to the object, the perimeter of the contact zone being within zero to 24 inches of the object.

5. The method of claim 1 further including the steps of:
a) performing motion tracking of the patient; and
b) defining a contact zone based on proximity to the patient, the perimeter of the contact zone being within zero to 24 inches of the patient.

6. The method of claim 4, wherein the shape of the perimeter of the contact zone at least substantially matches the shape of the perimeter of the object on at least two of four sides.

7. The method of claim 4 further including the steps of:
a) monitoring a field of view using the area monitor, the field of view at least partially including the contact zone; and
b) detecting entry of the service provider into the contact zone by motion tracking the movement of the service provider within the field of view.

8. The method of claim 7 further including the step of identifying the service provider being tracked, wherein identifying the service provider includes the steps of:
a) emitting a badge line-of-sight pulse from the badge; and
b) detecting the badge line-of-sight pulse in the field of view of the area monitor.

9. The method of claim 8, wherein:
a) the badge line-of-sight pulse is detected at least partially within a silhouette of the service provider, the silhouette being detected using motion tracking, and
b) identifying the service provider further includes the step of associating the badge line-of-sight pulse with the service provider in whose silhouette the line-of-sight pulse is detected.

10. The method of claim 8, wherein:
a) identifying the service provider further includes the steps of:
1) sending an activate command from the area monitor to the badge; and
2) emitting the badge line-of-sight pulse from the badge in response to the activate command, and
b) the sending the activate command is sequentially repeated for each service provider in the area, each activate command including information that uniquely identifies the badge that is to emit a badge line-of-sight pulse in response to each activate command.

11. The method of claim 10 further including the steps of:
a) determining whether the cleaning agent was dispensed from the cleaning agent dispenser a period of time before entry of the service provider into the contact zone;
b) identifying a first noncompliance event if the cleaning agent is not dispensed from the cleaning agent dispenser the period of time before entry of the service provider into the contact zone; and
c) communicating a first noncompliance alert to the service provider if the first noncompliance event is identified.

12. The method of claim 11 further including the steps of:
a) dividing the contact zone into a first contact subzone and a second contact subzone; and
b) identifying a second noncompliance event if the cleaning agent is not dispensed from the cleaning agent dispenser before the service provider moves from the first contact subzone to the second contact subzone.

13. The method of claim 11 further including the steps of:
a) defining a caution zone based on proximity to the object, the caution zone extending beyond the contact zone; and
b) detecting entry of the service provider into the caution zone by tracking the movement of the service provider within the field of view.

14. The method of claim 13 further including the step of identifying a third noncompliance event if the service provider exits and reenters the caution zone without dispensing cleaning agent from the dispenser.

15. The method of claim 13 further including the steps of:
a) identifying a caution event if the cleaning agent is not dispensed from the cleaning agent dispenser the period of time before entry of the service provider into the caution zone;
b) communicating a cautionary alert to the service provider if the caution event is identified; and
c) communicating a noncompliance alert to the service provider if the noncompliance event is identified.

16. A method for monitoring patient safety in an area, the area including an area monitor and a cleaning agent dispenser, the method including:
a) performing object recognition of an object in the area using the area monitor;
b) defining a contact zone based on proximity to the object, the perimeter of the contact zone being within zero to 24 inches of the object;
c) monitoring a field of view using the area monitor, the field of view at least partially including the contact zone;
d) detecting entry of a service provider into the contact zone by tracking the movement of the service provider within the field of view; and
e) determining whether cleaning agent is dispensed from the cleaning agent dispenser:
1) while the service provider is within a dispensing distance of the cleaning agent dispenser, and
2) within a period of time prior to entry into the contact zone by the service provider.

17. The method of claim 16 further including the steps of:
a) performing motion tracking of the patient; and
b) defining a contact zone based on proximity to the patient, the perimeter of the contact zone being within zero to 24 inches of the patient.

18. The method of claim 16, wherein the shortest paths from substantially all points on the perimeter of the object to the perimeter of the contact zone are at least substantially equal.

19. The method of claim 16 further including the steps of:
a) recording a first noncompliance event if cleaning agent is not dispensed from the cleaning agent dispenser within a period of time prior to entry into the contact zone; and
b) communicating a first noncompliance alert to the service provider if the first noncompliance event is recorded.

20. The method of claim 19 further including the steps of:
a) dividing the contact zone into a first contact subzone and a second contact subzone; and
b) recording a second noncompliance if the cleaning agent is not dispensed from the cleaning agent dispenser after the service provider leaves the first contact subzone but before the service provider enters the second contact subzone.

21. The method of claim 19 further including the steps of:
a) defining a caution zone based on proximity to the object, the caution zone extending beyond the contact zone;
b) detecting entry of the service provider into the caution zone by tracking the movement of the service provider within the field of view;
c) identifying a caution event if cleaning agent is not dispensed from the cleaning agent dispenser within a period of time prior to entry into the caution zone; and
d) communicating a cautionary alert to the service provider if a caution event is identified.

22. The method of claim 19 further including the steps of:
a) defining a caution zone based on proximity to the object, the caution zone extending beyond the contact zone;
b) detecting entry of the service provider into the caution zone by tracking the movement of the service provider within the field of view; and
c) recording a third noncompliance event if the service provider exits and reenters the caution zone without dispensing cleaning agent from the dispenser.

23. The method of claim 16 further including the step of identifying the service provider who dispensed cleaning agent from the cleaning agent dispenser, wherein identifying the service provider includes the steps of:
a) sending a dispenser line-of-sight signal from the dispenser to a badge carried by the service provider, the dispenser line-of-sight signal including information that uniquely identifies the dispenser;
b) sending a second non-line-of-sight signal from the badge to the dispenser, the second non-line-of-sight signal including information that uniquely identifies the service provider; and
c) sending a dispenser non-line-of-sight signal from the dispenser to an area monitor, the dispenser non-line-of-sight signal including information that uniquely identifies the service provider.

24. The method of claim 16 further including the step of identifying the service provider being tracked, wherein:
a) identifying the service provider includes the steps of:
1) sending an activate command from an area monitor to a badge carried by the service provider;
2) emitting a badge line-of-sight pulse from the badge in response to the activate command;
3) detecting the badge line-of-sight pulse in the field of view of the area monitor; and
4) associating the badge line-of-sight pulse with the service provider, and
b) sending the activate command is sequentially repeated for each service provider in the area, each activate command including information that uniquely identifies the badge that is to emit a badge line-of-sight pulse in response to each activate command.

25. The method of claim 16 further including the steps of:
a) emitting a monitor line-of-sight signal from an area monitor into the area so as to at least substantially saturate at least a portion of the area with the monitor line-of-sight signal, the monitor line-of-sight signal including information that uniquely identifies the area;
b) detecting the monitor line-of-sight signal using a badge carried by the service provider entering the area; and
c) sending a first non-line-of-sight signal from the badge to the area monitor, the first non-line-of-sight signal including information that uniquely identifies the service provider carrying the badge.

26. An area monitor for monitoring patient safety in an area, the area including a cleaning agent dispenser, the area monitor being configured to:
a) perform object recognition of an object in the area;
b) define a contact zone based on proximity to the object, the contact zone being within a reachable distance of the object;
c) monitor a field of view, the field of view at least partially including the contact zone;
d) detect entry of a service provider into the contact zone by tracking the movement of the service provider within the field of view; and
e) determine whether cleaning agent is dispensed from the cleaning agent dispenser:
1) while the service provider is within a dispensing distance of the cleaning agent dispenser, and
2) within a period of time prior to entry into the contact zone.

27. The area monitor of claim 26, wherein the shape of the perimeter of the contact zone at least substantially matches the shape of the perimeter of the object on at least two of four sides.

28. The area monitor of claim 26 further configured to:
a) perform motion tracking of the patient; and
b) define a contact zone based on proximity to the patient, the perimeter of the contact zone being within zero to 24 inches of the patient.

29. The area monitor of claim 26 further configured to:
a) divide the contact zone into a first contact subzone and a second contact subzone;
b) define a caution zone based on proximity to the object, the caution zone extending beyond the contact zone;
c) detect entry of the service provider into the caution zone by tracking the movement of the service provider within the field of view;
d) record a caution event if cleaning agent is not dispensed from the cleaning agent dispenser within the period of time prior to entry into the caution zone;
e) record a first noncompliance event if cleaning agent is not dispensed from the cleaning agent dispenser within the period of time prior to entry into the caution zone; and
f) record a second noncompliance event if the cleaning agent is not dispensed from the cleaning agent dispenser before the service provider moves from the first contact subzone to the second contact subzone;
g) communicate a cautionary alert to the service provider if a caution event is recorded; and
h) communicate a noncompliance alert to the service provider if a noncompliance event is recorded.

30. The area monitor of claim 29 further configured to record a third noncompliance event if the service provider exits and reenters the caution zone without dispensing cleaning agent from the dispenser.
